(19) United States
(12) Patent Application Publication
(10) Pub. No.: US 2025/0182004 A1
(43) Pub. Date: Jun. 5, 2025

(54) TASK CREATION METHOD, APPARATUS, ELECTRONIC DEVICE, STORAGE MEDIUM AND PROGRAM PRODUCT

(71) Applicant: Beijing Zitiao Network Technology Co., Ltd., Haidian District, Beijing (CN)

(72) Inventors: Danni Wu, Beijing (CN); Yonghui Pan, Beijing (CN); Jian Sun, Beijing (CN); Yongning Fu, Beijing (CN); Xuebin Yang, Beijing (CN)

(21) Appl. No.: 18/837,566

(22) PCT Filed: Feb. 8, 2023
(86) PCT No.: PCT/CN2023/075025

§ 371 Date: Aug. 9, 2024

(30) Foreign Application Priority Data
Feb. 9, 2022 (CN) 202210122084.0
Jun. 17, 2022 (CN) 202210693458.4

(51) Int. Cl. G06Q 10/0631; G06Q 10/10

(52) U.S. Cl. CPC G06Q 10/06311; G06Q 10/103

(57) ABSTRACT

A task creation method, comprising: in response to an operation for adding a task to a first document, creating a task type block in the first document; in response to a wakeup operation for a preset panel in the task type block of the first document, displaying the preset panel and displaying a target option in the preset panel, wherein the target option is used for giving a prompt that when selected, the target option triggers the creation, at a target client, of a task corresponding to the task type block; and when the target option is selected, in response to a specified operation which is completed in the preset panel, creating, at the target client, the task corresponding to the task type block. Further provided are a task creation apparatus, an electronic device, and a storage medium.

### CROSS-REFERENCE TO RELATED APPLICATION(S)

The disclosure claims the priority to Chinese Patent Application No. 202210122084.0, filed on Feb. 9, 2022 and entitled “TASK CREATION METHOD AND APPARATUS, ELECTRONIC DEVICE, STORAGE MEDIUM, AND PROGRAM PRODUCT”, and the priority to Chinese Patent Application No.202210693458.4, filed on Jun. 17, 2022 and entitled “TASK CREATION METHOD AND APPARATUS, ELECTRONIC DEVICE, AND STORAGE MEDIUM”, the disclosure of which are incorporated in their entireties herein by reference.

### FIELD

The disclosure relates to the technical field of computers, and particularly relates to a task creation method and apparatus, an electronic device, and a storage medium.

### BACKGROUND

As e-office is popularized, a user has become increasingly accustomed to creating a task with an e-office product, such that the user can record and plan the user's work progress. However, various e-office products that the user may simultaneously use all have a function of creating a task. For instance, the user can create a task in a document or in a task panel.

In the related art, the user create tasks independently in different e-office products, and the same task needs to be created repeatedly in different e-office products, so task creation efficiency is not high.

### SUMMARY

In order to solve the above technical problem, the disclosure provides a task creation method and apparatus, an electronic device, and a storage medium, so as to improve task creation efficiency.

In a first aspect, the disclosure provides a method for task creation. The method includes:
creating, in response to an operation of adding a task into a first document, a task type block in the first document;
displaying, in response to an invocation operation for a preset panel in the task type block of the first document, the preset panel and a target option in the preset panel, where the target option is configured to give a prompt that a task corresponding to the task type block is to be triggered to be created in a target client when being selected; and
creating, in response to a specified operation completed in the preset panel, the task corresponding to the task type block in the target client in a case that the target option is selected.

In a second aspect, an example of the disclosure provides a method for task creation. The method includes:
creating, in response to an operation of adding a task into a first document, a first task type block in the first document;
converting, in response to a triggering operation for a preset control in the first task type block of the first document, the first task type block into a second task type block, where the first task type block and the second task type block have different content block types; and
creating, according to the second task type block, a task corresponding to the second task type block in the first document.

In a third aspect, an example of the disclosure provides an apparatus for task creation. The apparatus includes:
a task type block creation module configured to create, in response to an operation of adding a task into a first document, a task type block in the first document;
a displaying module configured to display, in response to an invocation operation for a preset panel in the task type block of the first document, the preset panel and a target option in the preset panel, where the target option is configured to give a prompt that a task corresponding to the task type block is to be triggered to be created in a target client when being selected; and
a task creation module configured to create, in response to a specified operation completed in the preset panel, the task corresponding to the task type block in the target client in a case that the target option is selected.

In a fourth aspect, an example of the disclosure provides an apparatus for task creation. The apparatus includes:
a creation module configured to create, in response to an operation of adding a task into a first document, a first task type block in the first document; and
a processing module configured to convert, in response to a triggering operation for a preset control in the first task type block of the first document, the first task type block into a second task type block, where the first task type block and the second task type block have different content block types; and
the processing module is further configured to create, according to the second task type block, a task corresponding to the second task type block in the first document.

In a fifth aspect, an example of the disclosure provides an electronic device. The electronic device includes:
one or more processors; and
a storage unit configured to store one or more programs.

When the one or more programs are executed by the one or more processors, the one or more processors are caused to implement the method according to the first aspect or the second aspect.

In a sixth aspect, an example of the disclosure provides a computer-readable storage medium, which stores a computer program. When the computer program is executed by a processor, the method according to the first aspect or the second aspect is implemented.

Compared with the prior art, the technical solution according to the example of the disclosure has the following advantages:

In the method and apparatus for task creation, the electronic device, the storage medium and a program product according to the examples of the disclosure, in response to the operation of adding the task into the first document, the task type block is created in the first document, in response to the invocation operation for the preset panel in the task type block of the first document, the preset panel is displayed and the target option is displayed in the preset panel, and in response to the specified operation completed in the preset panel, the task corresponding to the task type block is created in the target client in a case that the target option is selected. That is, after the preset panel is invoked in the task type block, the task corresponding to the task type block can be created in a client through a selection operation for the target option of the preset panel, such that task creation efficiency can be improved.

### BRIEF DESCRIPTION OF THE DRAWINGS

Accompanying drawings herein are incorporated in the description as a constituent part of the description, illustrate examples conforming to the disclosure, and serve to describe principles of the disclosure together with the description.

To more clearly describe technical solutions in the examples of the disclosure or in the prior art, the accompanying drawings required for description of the examples or the prior art will be briefly introduced below. Obviously, those of ordinary skill in the art can also derive other accompanying drawings from these accompanying drawings without making inventive efforts.

FIG. 1 is a schematic flow diagram of a method for task creation according to an example of the disclosure;

FIG. 2 is a schematic diagram of a task creation interface according to an example of the disclosure;

FIG. 3 is a schematic diagram of another task creation interface according to an example of the disclosure;

FIG. 4 is a schematic diagram of yet another task creation interface according to an example of the disclosure;

FIG. 5 is a schematic diagram of yet another task creation interface according to an example of the disclosure;

FIG. 6 is a schematic diagram of yet another task creation interface according to an example of the disclosure;

FIG. 7 is a schematic diagram of yet another task creation interface according to an example of the disclosure;

FIG. 8 is a schematic diagram of yet another task creation interface according to an example of the disclosure;

FIGS. 9A-9G are schematic diagrams of still another task creation interface according to an example of the disclosure;

FIG. 10 is a schematic flow diagram of an example of another method for task creation according to the disclosure;

FIG. 11 is a schematic structural diagram of an apparatus for task creation according to the disclosure;

FIG. 12 is a schematic structural diagram of another apparatus for task creation according to the disclosure; and

FIG. 13 is a schematic diagram of an electronic device according to an example of the disclosure.

### DETAILED DESCRIPTION OF EMBODIMENTS

To make the above objectives, features and advantages of the disclosure more obvious and comprehensible, the solution of the disclosure will be further described below. It should be noted that examples of the disclosure and the features of the examples may be combined with each other without conflict.

Many specific details are set forth in the following description to facilitate full understanding of the disclosure, and the disclosure can also be implemented in other ways different from those described herein. Obviously, the examples in the description are only some examples rather than all examples of the disclosure.

In the related art, after a user selects a user who receives a task and reminder time of the task on a person selection component panel and/or a date selector panel in a main process of a method for task creation, the task may be created by triggering to-do task creation set on a task type block. However, in the related art, after the user selects the user who receives the task and the reminder time of the task in the person selection component panel and/or the date selector panel, if the to-do task creation set on the task type block is not triggered, a task corresponding to the task type block cannot be converted into a corresponding task, and task creation efficiency is low.

Based on this, the disclosure provides the method and apparatus for task creation, an electronic device, a storage medium, and a program product, where in response to an operation of adding a task into a first document, a task type block is created in the first document, in response to an invocation operation for a preset panel in the task type block of the first document, the preset panel is displayed and a target option is displayed in the preset panel, and in response to a specified operation completed in the preset panel, a task corresponding to the task type block is created in a target client in a case that the target option is selected. That is, after the preset panel is invoked in the task type block, the task corresponding to the task type block may be created in a client through a selection operation for the target option of the preset panel, such that task creation efficiency can be improved.

The method for task creation according to the disclosure is executed by the electronic device or an application in the electronic device. The electronic device may be a tablet computer, a mobile phone, a wearable device, a vehicle-mounted device, an augmented reality (AR)/virtual reality (VR) device, a notebook computer, an ultra-mobile personal computer (UMPC), a netbook, a personal digital assistant (PDA), a smart television, a smart screen, a high-definition television, a 4K television, a smart speaker, a smart projector, etc. The disclosure does not limit a specific type of the electronic device.

The disclosure does not limit a type of an operating system of the electronic device. For instance, the operating system may be an Android system, a Linux system, a Windows system, an iOS system, etc.

The technical solution of the disclosure will be described in detail below in conjunction with several specific examples.

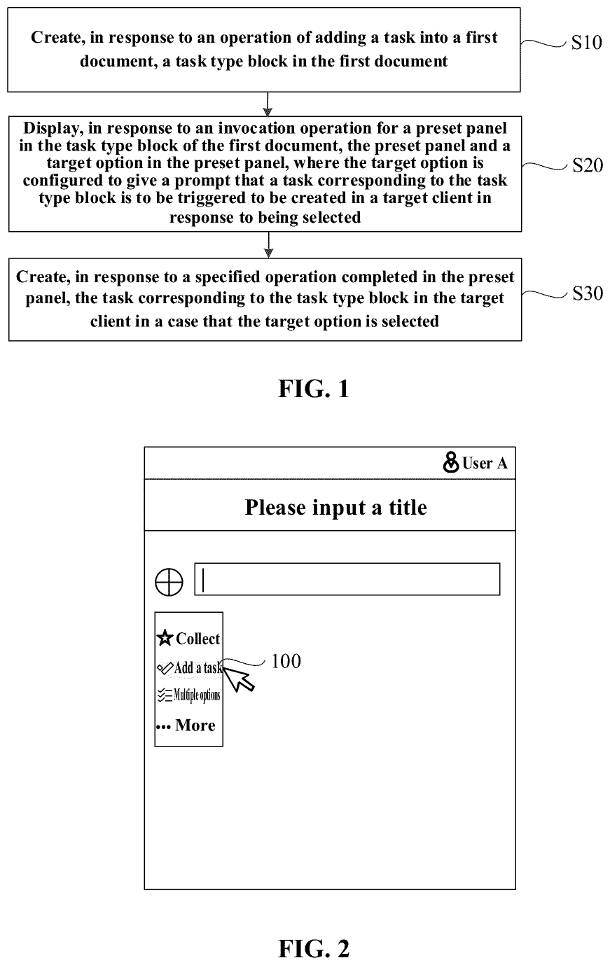

FIG. 1 is a schematic flow diagram of a method for task creation according to the disclosure. As shown in FIG. 1, the method of the example includes the following steps:
S10, in response to an operation of adding a task into a first document, a task type block is created in the first document.

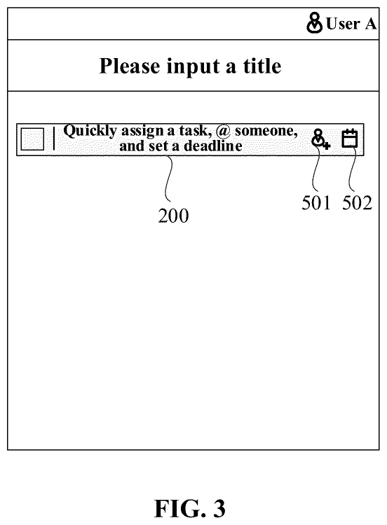

Specifically, the task type block refers to a task type block corresponding to a zone created after the operation of adding the task is triggered in the first document. As one embodiment, as shown in FIG. 2, for instance, after a user places a cursor at a position corresponding to text of the first document, if the user triggers a key of adding a task 100 at the text of the first document, a task type block 200 displayed in the first document is as shown in FIG. 3.
S20, in response to an invocation operation for a preset panel in the task type block of the first document, the preset panel is displayed and a target option is displayed in the preset panel. The target option is configured to give a prompt that a task corresponding to the task type block is to be triggered to be created in a target client when being selected.

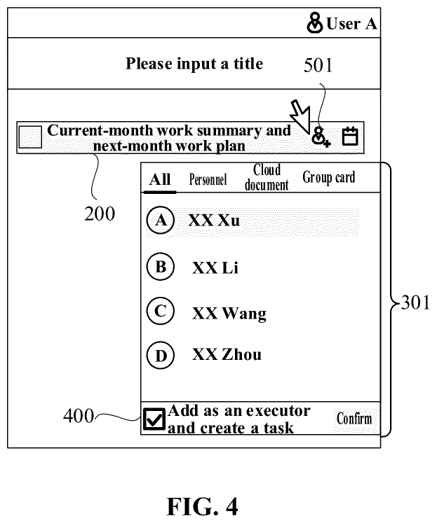

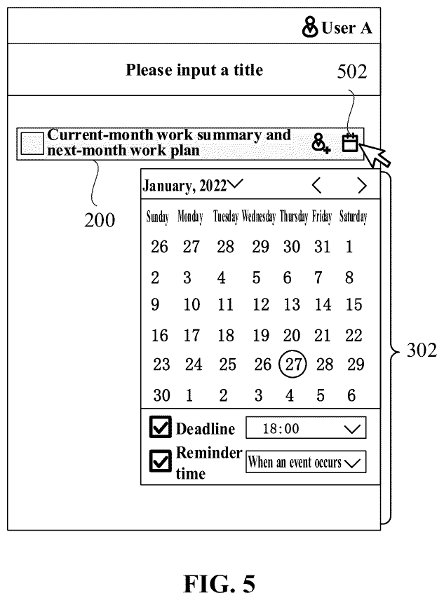

With reference to FIG. 3, a preset panel 300 includes a person selection component panel, a date selector panel, etc. In response to the invocation operation for the preset panel in the task type block of the first document, the preset panel is displayed and the target option is displayed in the preset panel. Specifically, as shown in FIG. 4 or 5, a task corresponding to the task type block 200 may be created by triggering a target option 400 of a preset panel 301 or a preset panel 302, and task creation efficiency of the user can be improved.

The invocation operation includes an operation of triggering to open, triggering to select, etc., and for instance, triggering to open a person selection component panel 301 or triggering to open a date selector panel 302. In response to triggering to open the person selection component panel 301, as shown in FIG. 4, a user who receives a task reminder may be selected in the person selection component panel 301. In response to triggering to open the date selector panel 302, task reminder time may be selected in the date selector panel 302.

In addition, in the person selection component panel 301 that is triggered to be opened, all personnel, or personnel having document operation authority, or personnel in a group card may be selected as the user who receives the task reminder, which is not specifically limited in the example of the disclosure. In the date selector panel 302 that is triggered to be opened, a deadline of the task created may be selected in addition to the task reminder time. A state of the reminder time may be time when an event occurs, or preset time before an event occurs, which may be customized by the user through selection, which is not specifically limited in the example of the disclosure.

It should be noted that a number of the users who receive the task reminder that are selected in the person selection component panel 301 may be one or more, and the task reminder time selected in the date selector panel 302 may be specific time or a certain period, which is not specifically limited in the example of the disclosure.

After the user conducts the invocation operation for the preset panel 301 or 302 in the task type block, the target option 400 is displayed in the preset panel 301 or 302, such that the user may trigger the target option 400 in the preset panel 301 or 302, and then the task corresponding to the task type block 200 may be created in the target client.

As one embodiment, if the preset panel is the person selection component panel 301, in response to the invocation operation for the person selection component panel 301 in the task type block 200 of the first document, the person selection component panel is displayed and the target option is displayed in the person selection component panel as shown in FIG. 4. In FIG. 4, after the user conducts the invocation operation for the person selection component panel in the task type block of the first document, the target option 400 is displayed in the person selection component panel 301.

It should be noted that FIG. 4 illustratively shows that after the user conducts the invocation operation for the person selection component panel in the task type block of the first document, the target option 400 is displayed in the person selection component panel 301, and the target option 400 displays “add as an executor and create a task”. In other embodiments, after the user conducts the invocation operation for the person selection component panel in the task type block of the first document, the target option 400 is displayed in the person selection component panel 301, and the target option 400 displays “add as a follower and create a task”, which is not specifically limited in the example of the disclosure.

As another embodiment, if the preset panel is the date selector panel 302, in response to the invocation operation for the date selector panel 302 in the task type block of the first document, the date selector panel 302 is displayed and the target option 400 is displayed in the date selector panel 302 as shown in FIG. 5. In FIG. 5, after the user conducts the invocation operation for the date selector panel in the task type block of the first document, the target option is displayed in the date selector panel.
S30, in response to a specified operation completed in the preset panel, the task corresponding to the task type block is created in the target client in a case that the target option is selected.

After the user triggers to select of the target option 400 in the preset panel, a corresponding task in the task type block of the first document is created in the target client based on a specified operation completed in the person selection component panel 301. With reference to FIG. 4, after the user conducts a selection operation on the target option 400 in the preset panel and triggers a confirm key, the task corresponding to the task type block of the first document is created in the target client. With reference to FIG. 5, after the user conducts a selection operation on the target option 400 in the preset panel, the task corresponding to the task type block of the first document is created in the target client based on a specified operation completed in the date selector panel 302.

For example, the specified operation completed in the person selection component panel 301 includes an operation of selecting an executor who executes the task, and the specified operation completed in the date selector panel 302 includes an operation of selecting reminder time of the task and a deadline of the task.

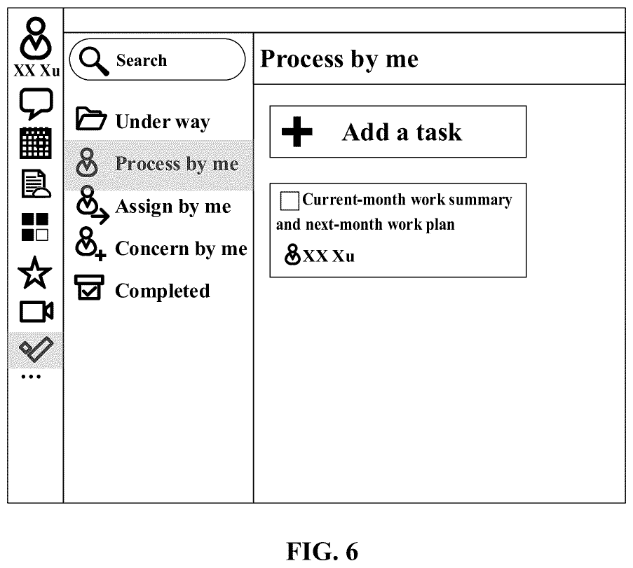

Specifically, after user A selects a user XX Xu in a corresponding person selection component panel 301 in FIG. 4, the user XX Xu may view the task in a task bar of the target client, as shown in FIG. 6.

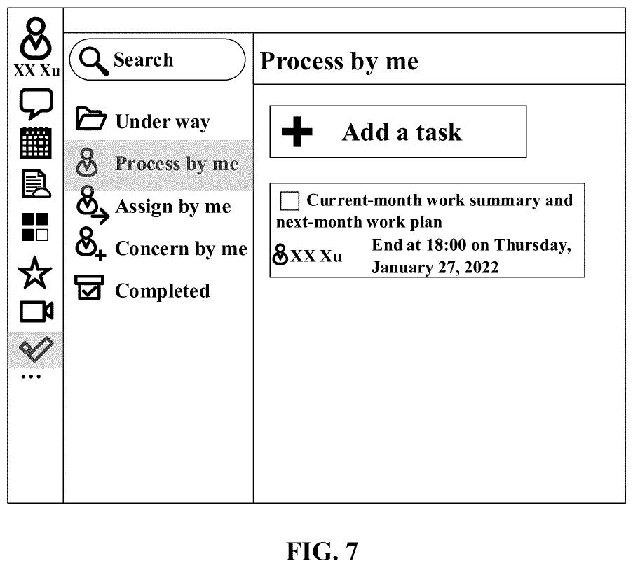

It should be noted that FIG. 6 illustratively shows that after the user A selects the user XX Xu in the corresponding person selection component panel 301 in FIG. 4, the user XX Xu may view the task in the task bar of the target client. After the user A selects the user XX Xu in the corresponding person selection component panel 301 in FIG. 4, the user A selects a task deadline 18:00 in the corresponding date selector panel 302 in FIG. 5, and task reminder time is time when the task occurs. In this case, the user XX Xu may view the task in the task bar of the target client, as shown in FIG. 7. In addition, corresponding to the time when the task occurs, XX Xu may receive a reminder message of the task in the target client.

It should be noted that the target client is different from a client where the first document is located.

In addition, in the above example, FIG. 4 illustratively shows that in response to the invocation operation for the person selection component panel in the task type block of the first document, based on the selection operation for the person selection component panel, the task corresponding to the task type block of the first document is created in the target client. FIG. 5 illustratively shows that in response to the invocation operation for the date selector panel in the task type block of the first document, based on the selection operation for the date selector panel, the task corresponding to the task type block of the first document is created in the target client. In other specific embodiments, the task corresponding to the task type block may be created in the target client in response to the invocation operations for the person selection component panel and the date selector panel in the task type block of the document based on the selection operations for the person selection component panel and the date selector panel.

After the user conducts the selection operation on the target option, the task corresponding to the task type block is displayed in the task bar of the target client, and the created task is prompted through prompt information. It is ensured that the user may receive the created task in time and then execute the task.

In the method for task creation according to the example of the disclosure, in response to the operation of adding the task into the first document, the task type block is created in the first document, in response to the invocation operation for the preset panel in the task type block of the first document, the preset panel is displayed and the target option is displayed in the preset panel, and in response to the specified operation completed in the preset panel, the task corresponding to the task type block is created in the target client in a case that the target option is selected. That is, after the preset panel is invoked in the task type block, the task corresponding to the task type block can be created in the client through the selection operation for the target option of the preset panel, such that task creation efficiency can be improved.

As one embodiment, the target option includes a check box. Prompt information is correspondingly displayed near the check box. The prompt information is configured to give a prompt of creating, in response to the specified operation completed in the preset panel, the task in the target client in a case that the check box is selected.

Specifically, with reference to FIG. 4, in response to the invocation operation for the person selection component panel 301 in the task type block 200 of the first document, the target option 400 is displayed in the person selection component panel 301, and the task is created in the target client by selecting the target option 400.

For instance, the target option 400 is the check box, and the prompt information is displayed as “add as an executor and create a task”. After the check box is selected and the confirm key is triggered, task creation is completed in the target client.

It should be noted that FIG. 4 illustratively shows that the target option 400 is in a form of the check box. In a specific embodiment, the example of the disclosure does not limit a specific form of a preset key.

As another embodiment, the target option 400 includes a preset key. The preset key is configured to create, in response to the specified operation completed in the preset panel, the task in the target client on the premise of being selected.

Specifically, with reference to FIG. 5, in response to the invocation operation for the date selector panel 301 in the task type block 200 of the first document, the preset key is displayed in the date selector panel 301, and the task is created in the target client by selecting the preset key.

For instance, the preset key displays the prompt information “convert into a task”. After the preset key is selected, task creation is completed in the target client.

It should be noted that FIG. 5 illustratively shows a form of the preset key. In a specific embodiment, the example of the disclosure does not limit a specific form of a preset key.

One embodiment of the steps that in response to the invocation operation for the preset panel in the task type block of the first document, the person selection component panel is displayed and the target option is displayed in the person selection component panel includes the following steps:
in response to the invocation operation for the person selection component panel in the task type block of the first document by inputting a preset character, the person selection component panel is displayed and the target option is displayed in the person selection component panel.

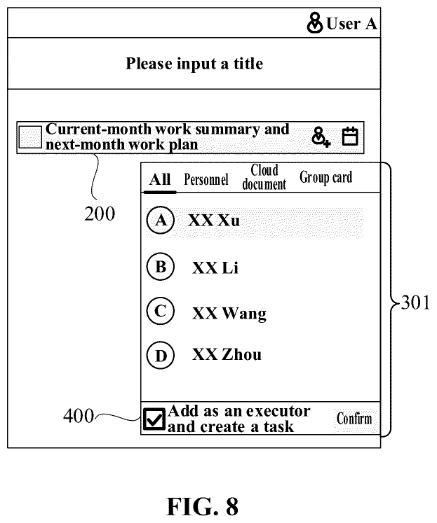

Specifically, the person selection component panel is invoked by inputting the preset character into the task type block of the first document. For instance, as shown in FIG. 8, after a character “@” is input into the task type block 200 of the first document, the person selection component panel is invoked.

Another embodiment of the steps that in response to the invocation operation for the preset panel in the task type block of the first document, the person selection component panel is displayed and the target option is displayed in the person selection component panel includes the following steps:
in response to the invocation operation for the person selection component panel in the task type block of the first document by clicking on a person selection component icon 501, the person selection component panel is displayed and the target option is displayed in the person selection component panel.

Specifically, the person selection component panel is invoked by clicking on the person selection component icon 501 in the task type block of the first document. For instance, with reference to FIG. 4, after the person selection component icon 501 is clicked on in the task type block 200 of the first document, the person selection component panel 301 is invoked.

One embodiment of the steps that in response to the invocation operation for the date selector panel in the task type block of the first document, the date selector panel is displayed and the target option is displayed in the date selector panel includes the following steps:
in response to the invocation operation for the date selector panel in the task type block of the first document by clicking on a date selector icon 502, the date selector panel is displayed and the target option is displayed in the date selector panel 302.

Specifically, the date selector panel 302 is invoked by clicking on the date selector icon 502 in the task type block 200 of the first document. For instance, with reference to FIG. 5, after the date selector icon 502 is clicked on in the task type block of the first document, the date selector panel 302 is invoked.

It should be noted that in the above example, one embodiment of clicking on the date selector icon 502 or clicking on the person selection component icon 501 in the task type block 200 of the first document includes clicking, and another embodiment includes double-clicking. The example of the disclosure does not limit a specific mode of clicking.

In the example, in S30, one specific embodiment of the step that the task corresponding to the task type block is created in the target client includes the following steps:
Step one: a document client transmits editing information of the task corresponding to the task type block to a task server. The editing information includes: index information of the task and editing data of the task.

The task server receives the editing information, transmitted by the document client, of the task corresponding to the task type block. The editing information includes: the index information of the task and the editing data of the task.

After the task is edited in the task type block of the document client, the document client transmits the editing information of the task corresponding to the task type block to the task server, and then the task server transmits the index information of the task to the target client, such that the target client creates the task based on the index information of the task.

Specifically, the editing information, transmitted by the document client, of the task corresponding to the task type block includes the index information of the task and the editing data of the task. A correspondence exists between the index information of the task and the editing data of the task.
Step two: the task server transmits the index information of the task to the target client, such that the target client creates the task based on the index information of the task.

Specifically, the task server receives an opening request of a task panel transmitted by the target client. The opening request includes: the index information of the task.

The task server transmits the editing data of the task to the target client based on the index information of the task, such that the target client displays the task based on the editing data of the task.

After the task server receives the editing information, transmitted by the document client, of the task corresponding to the task type block, the task server transmits the index information of the task to the target client. When the user triggers to open the task panel in the target client, the target client obtains the editing data of the task corresponding to the index information of the task from the task server based on the index information of the task and creates the task based on the editing data of the task.

For instance, after the user triggers the operation of adding the task in the first document and conducts the invocation operation on the preset panel in the created task type block, the document client transmits the editing information of the task corresponding to the task type block to the task server in a case that the target option of the preset panel is selected after the task corresponding to the task type block is created in the target client based on the specified operation completed in the preset panel. In this case, after the task server receives the editing information, transmitted by the document client, of the task corresponding to the task type block, the task server transmits the index information of the task in the editing information of the task to the target client. After the user triggers the opening request of the task panel in the target client, the target client transmits the index information of the task included in the opening request to the task server, and the task server transmits the editing data of the task to the target client based on the index information of the task, such that the target client may display the task based on the editing data of the task.

Before step two, the embodiment further includes the following step that the task server determines the target client based on a creator, an executor and/or a follower of the task included in the editing data of the task.

The creator of the task refers to a user who executes the operation of adding the task in the first document, and the executor and/or the follower of the task refers to the user who receives the task that is selected in the person selection component panel after the invocation operation is conducted on the person selection component panel in the task type block.

For instance, with reference to FIG. 4, in FIG. 4, the creator of the task refers to the user A, and the executor of the task is XX Xu. That is, XX Xu may receive the task corresponding to the task type block of the first document after entering the target client.

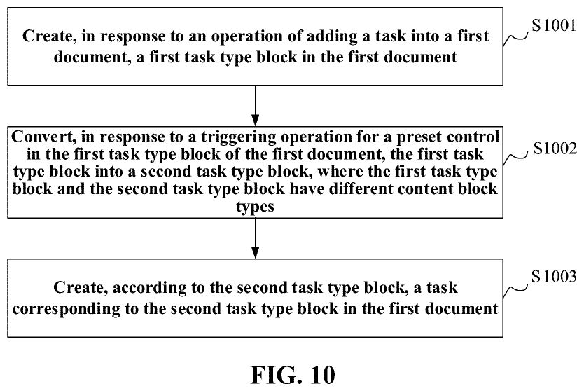

FIG. 10 is a schematic flow diagram of an example of another method for task creation according to the disclosure. The method of the example includes the following steps:
S1001: in response to an operation of adding a task into a first document, a first task type block is created in the first document.

The first document in the disclosure refers to an online document or a cloud document.

The step may include, but is not limited to, the following possible embodiments:

One possible embodiment is as follows: a user may locate a focus at a target position of the first document, invoke a task addition key by means of a preset control, and click on the task addition key, so as to create a first type block in the first document. Another possible embodiment is as follows: a user may create a first task type block in the first document by copying the created first task type block in the first document or another document into the first document. Specifically, after the user copies the created first task type block, the user executes a paste operation at the target position of the first document, and the paste operation is executed through a shortcut key or by clicking on a paste key, such that the first task type block may be created in the first document.

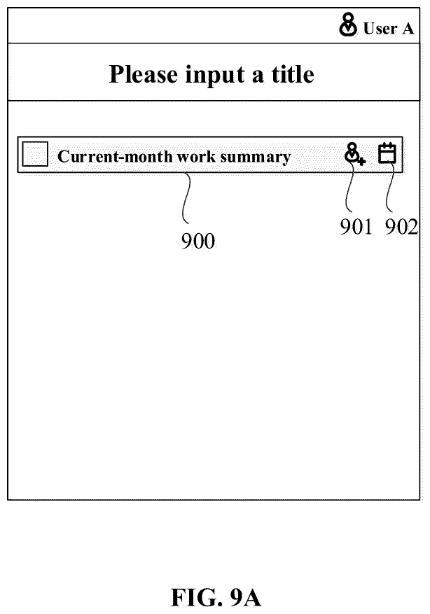

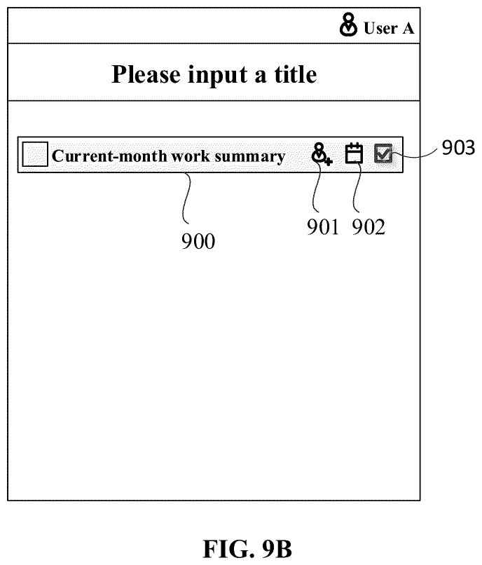

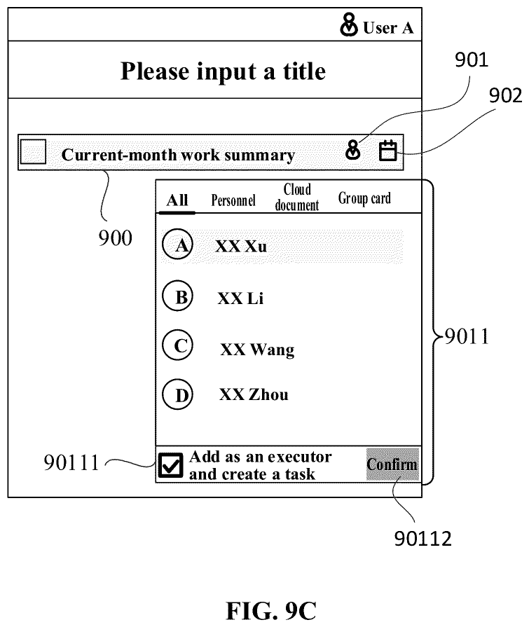

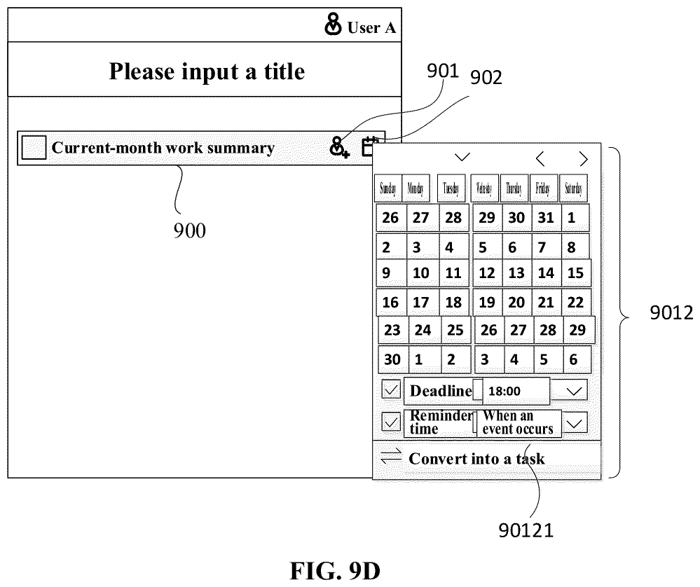

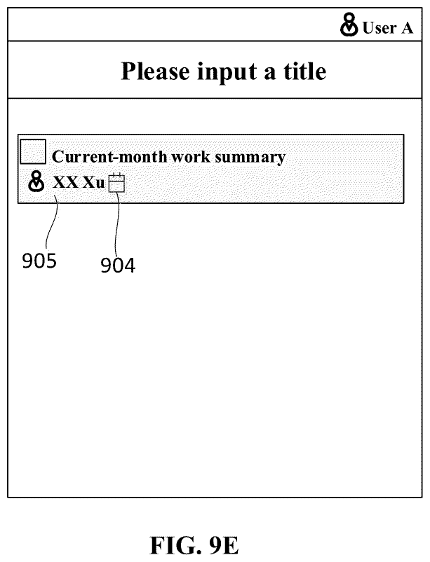

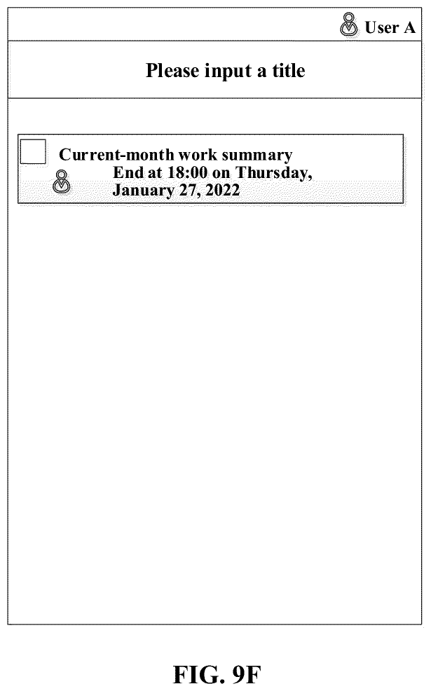

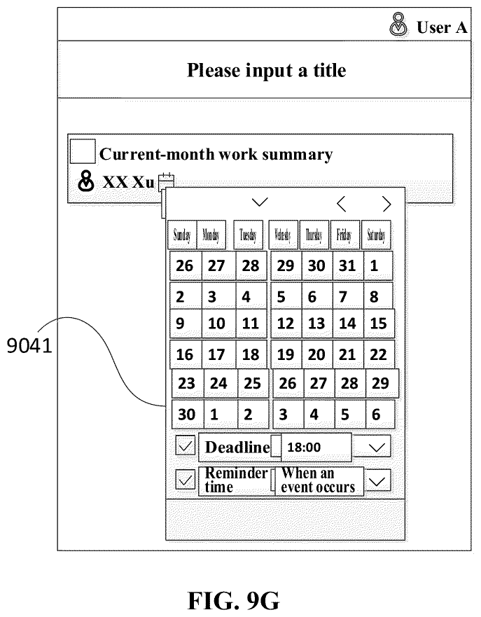

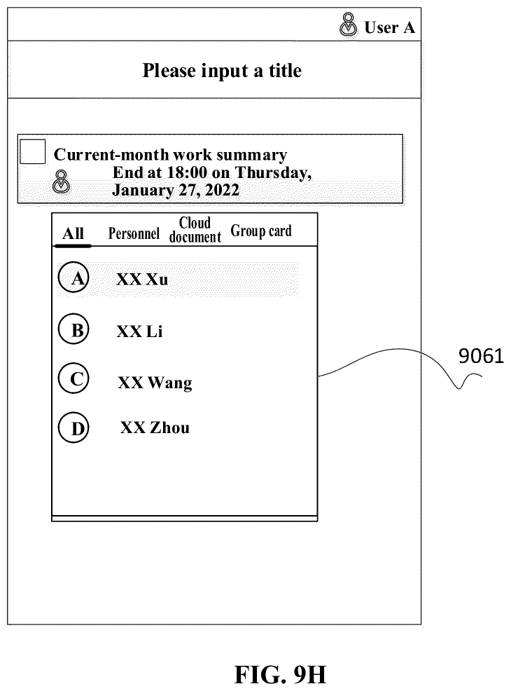

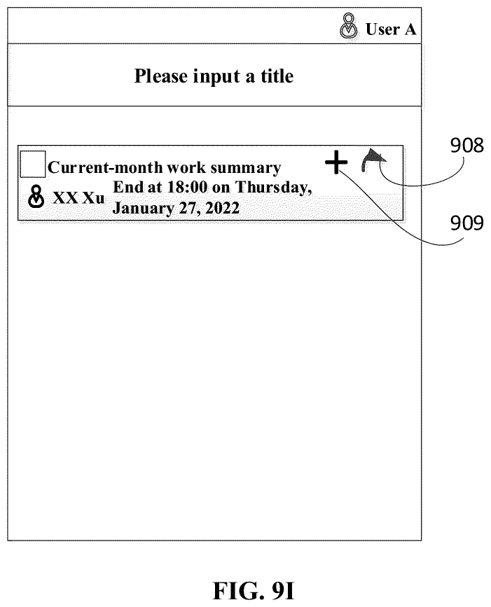

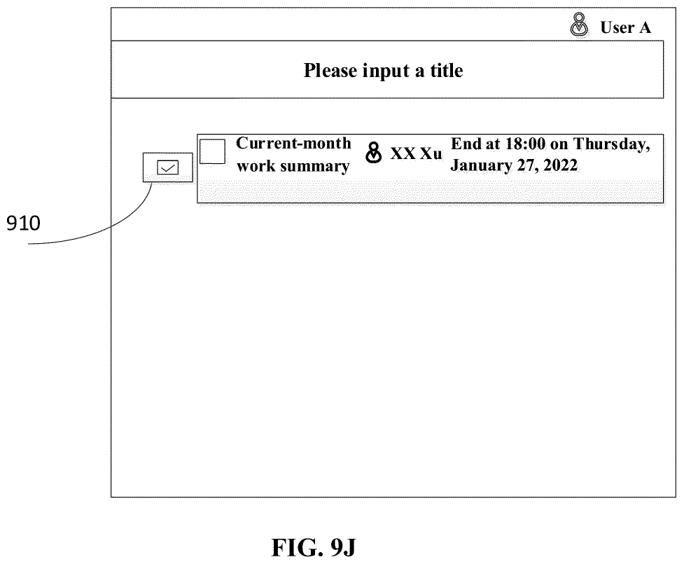

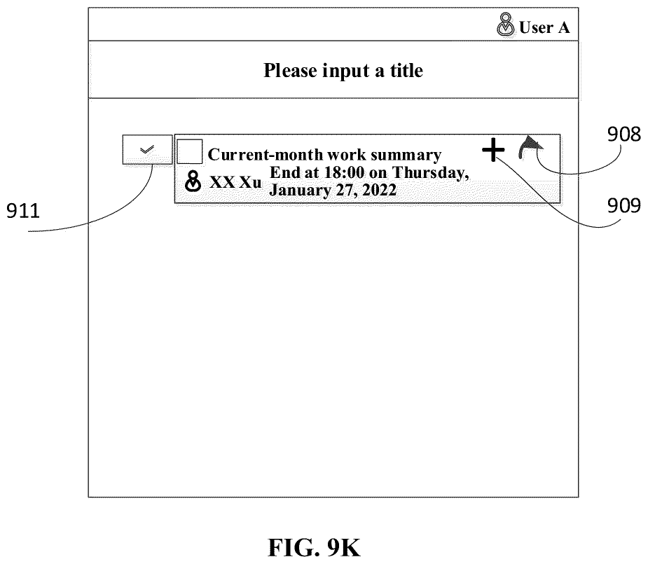

FIG. 9A is a schematic diagram of a first task type block according to the disclosure. With FIG. 9A as an instance, a first task type block 900 includes: a person selection component icon 901 and a date selector icon 902. A person selection component interface may be invoked for a person selection operation by triggering the person selection component icon, and a date selector interface may be invoked for time information setting by triggering the date selector icon.
S1002: in response to a triggering operation for a preset control in the first task type block of the first document, the first task type block is converted into a second task type block. The first task type block and the second task type block have different content block types.

The step includes, but is not limited to, the following two possible embodiments:

One possible embodiment is as follows: the first task type block includes: a conversion control, for instance, FIG. 9B includes a conversion control 903, and the user may trigger the conversion control 903 through clicking, etc., and may convert, in response to the triggering operation for the conversion control 903 in the first task type block of the first document, the first task type block into the second task type block.

Another possible embodiment is as follows: the user conducts an invocation operation on a preset panel in the first task type block, displays, in response to the invocation operation for the preset panel in the first task type block of the first document, the preset panel ands a target option in the preset panel, and converts, in response to a specified operation completed in the preset panel, the first task type block into the second task type block in a case that the target option is selected.

The preset panel includes, but is not limited to, a person selection component panel and a date selector panel.

With the person selection component panel as an instance, with reference to FIG. 9C, the user may invoke a person selection component panel 9011 by inputting a shortcut key (for instance, @) into the first task type block or clicking on the person selection component icon 901, and a target option 90111 is displayed in the person selection component panel 9011. After the person selection component panel 90111 is invoked, the user may conduct a person selection operation by means of the person selection component panel. For instance, a user “XX Xu” is selected, and the target option 90111 is also selected. A text description of the target option is, for instance, “add an executor and create a task”. The target option may be selected by selecting a check box, and the specified operation may be completed in the person selection component panel in a case that the target option is selected. For instance, a confirm key 90112 is selected, and in response to the specified operation completed in the person selection component panel, the first task type block is converted into the second task type block in the first document in a case that the target option is selected. The second task type block is as shown in FIG. 9D. The second task type block displays a date selector icon 904 and personnel information 905 selected through the person selection component panel. In the second task type block, the personnel information selected through the person selection component panel may be displayed below a task title. The personnel information 905 and the date selector icon 904 are simultaneously displayed. The date selector icon allows the user to further set time information. In response to a triggering operation of the user for the date selector icon 904, a date selector panel 9041 is displayed, as shown in FIG. 9E. The user sets the time information by means of the date selector panel. The interface after setting is finished is as shown in FIG. 9F.

With the date selector panel as an instance, with reference to FIG. 9C2, the user may invoke a date selector panel 9012 by clicking on the date selector icon, etc. The date selector panel 9012 displays a date selection option and a target option 90121. The user may set the time information by means of the date selector panel 9012 and also select the target option 90121. A text description of the target option is, for instance, “convert into a task”. The user may click on the target option 90121, and convert, in a case that the target option is selected, the first task type block into the second task type block in the first document in response to the specified operation completed in the date selector panel. The second task type block is as shown in FIG. 9D2. The second task type block displays a person selection component icon 906 and time information 907 selected through the date selector panel. The person selection component icon allows the user to further select the personnel information. The user invokes the person selection component panel 9061 by triggering the person selection component icon 906, as shown in FIG. 9E2. The user selects the personnel information by means of the person selection component panel 9061. The interface after the personnel information is selected is as shown in FIG. 9F.

In some examples, the second task type block further displays a first icon 908 and a second icon 909. The first icon 908 is configured to enter a task center after being triggered. The task center is integrated in an instant messaging client. The instant messaging client has an associated account relation with an online document. An account of the instant messaging client and an account of the online document may be the same one, or an account of the instant messaging client and an account of the online document are different accounts under the same organization. The second icon 909 is configured to follow the task after being triggered.

In some examples, when a focus is located on the first task type block, a first content block type identifier 910 is displayed in an associated zone of the first task type block, as shown in FIG. 9G1. When a focus is located on the second task type block, a second content block type identifier 911 is displayed in an associated zone of the second task type block, as shown in FIG. 9G2. Since the first task type block and the second task type block are different types of content blocks, the first task type block and the second task type block have different type block identifiers.
S803: according to the second task type block, a task corresponding to the second task type block is created in the first document.

Information such as task information, a task executor and task execution time/date may be created in the second task type block, which is equivalent to creation of the task corresponding to the second task type block in the first document after the above creation.

In the example, in response to the operation of adding the task into the first document, the first task type block is created in the first document; in response to the triggering operation for the preset control in the first task type block of the first document, the first task type block is converted into the second task type block; the first task type block and the second task type block have different content block types; and according to the second task type block, the task corresponding to the second task type block is created in the first document, such that the task type block may be quickly converted.

The target client may be an instant messaging application client. After the task is created, the same task in the document client and the instant messaging application client may implement synchronization of data modification by means of the task server, which is specifically as follows:

The task server receives editing information of a task transmitted by the document client, where the editing information of the task includes: index information of the task and editing data for modifying the task. The instant messaging application client containing the task is determined according to the index information of the task. The editing information of the task is transmitted to the instant messaging application client, such that the instant messaging application client synchronously modifies the task. Similarly, in response to receiving the editing information of the task transmitted by the instant messaging application client, the editing information of the task is transmitted to the document client, such that the document client synchronously modifies the task.

On the basis of the above example, in the document client, a document block is regarded as a minimum display unit of an online document, and one online document consists of one or more document blocks. The task occupies one document block in the online document, and the document block only stores the index information of the task.

On the basis of the above example, in response to an opening request for a document of the document client, a first data obtaining request is transmitted to the task server. The first data obtaining request includes: index information of the task corresponding to a task type document block in the document. A first data obtaining response transmitted by the task server is received. The first data obtaining response includes: task content data corresponding to the index information of the task. Based on the task content data corresponding to the index information of the task, the task content data is displayed at a position of the task type document block in the document.

On the basis of the above example, the method further includes the following steps: in response to an editing operation for task content data corresponding to index information of the task of the instant messaging application client, a data update request is transmitted to the task server, where the data update request includes: update content corresponding to the editing operation, such that the task server updates the task content data corresponding to the index information of the task.

On the basis of the above example, the method further includes the following steps: in response to an editing operation for task content data corresponding to index information of the task in the document of the document client, a data update request is transmitted to the task server, where the data update request includes: update content corresponding to the editing operation, such that the task server updates the task content data corresponding to the index information of the task.

On the basis of the above example, the method further includes the following steps: in response to an opening request for a task panel of the instant messaging application client, a second data obtaining request is transmitted to the task server, where the second data obtaining request includes: index information of a task included in the task panel; a second data obtaining response transmitted by the task server is received, where the second data obtaining response includes: task content data corresponding to the index information of the task; and based on the task content data corresponding to the index information of the task, the task content data corresponding to the index information of the task is displayed in the task panel.

On the basis of the above example, the step that in response to the opening request for the document of the document client, the first data obtaining request is transmitted to the task server includes the following steps: in response to the opening request for the document of the document client, index information of a task corresponding to a task type document block in the document is obtained from a document server, and the first data obtaining request is transmitted to the task server.

On the basis of the above example, the method further includes the following step: while the task type document block in the document is in an open state, a data update request transmitted by the task server is received. The data update request includes: update data. The data update request is configured to request the document to update and render the task type document block based on the update data received.

On the basis of the above example, the method further includes the following step: while the task panel in the instant messaging application client is in an open state, the data update request transmitted by the task server is received. The data update request includes: update data. The data update request is configured to request the task panel to update and render the task type document block based on the update data received.

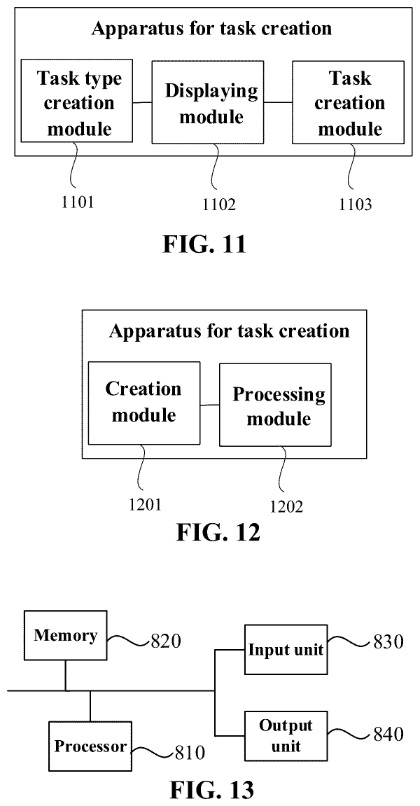

On the basis of the above example, an example of the disclosure further provides an apparatus for task creation. As shown in FIG. 11, the apparatus for task creation includes:
a task type block creation module 1101 configured to create, in response to an operation of adding a task into a first document, a task type block in the first document;
a displaying module 1102 configured to display, in response to an invocation operation for a preset panel in the task type block of the first document, the preset panel and a target option in the preset panel, where the target option is configured to give a prompt that a task corresponding to the task type block is to be triggered to be created in a target client when being selected; and
a task creation module 1103 configured to create, in response to a specified operation completed in the preset panel, the task corresponding to the task type block in the target client in a case that the target option is selected.

In the apparatus for task creation according to the example of the disclosure, the creation module creates, in response to the operation of adding the task into the first document, the task type block in the first document, the displaying module displays, in response to the invocation operation for the preset panel in the task type block of the first document, the preset panel ands the target option in the preset panel, and the task creation module is configured to create, in response to the specified operation completed in the preset panel, the task corresponding to the task type block in the target client in a case that the target option is selected. That is, after the preset panel is invoked in the task type block, the task corresponding to the task type block may be created in a client through a selection operation for the target option of the preset panel, such that task creation efficiency can be improved.

In some examples, one implementation mode of the displaying module includes the following steps:
in response to an invocation operation for a person selection component panel in the task type block of the first document, the person selection component panel is displayed and the target option is displayed in the person selection component panel.

In some examples, another implementation mode of the displaying module includes the following steps:
in response to an invocation operation for a date selector panel in the task type block of the first document, the date selector panel is displayed and the target option is displayed in the date selector panel.

In some examples, the task creation module is specifically configured to:
receive, by a task server, editing information, transmitted by a document client, of the task corresponding to the task type block, where the editing information includes: index information of the task and editing data of the task; and
transmit, by the task server, the index information of the task to the target client, such that the target client creates the task based on the index information of the task.

In some examples, the task creation module is further specifically configured to:
determine, by the task server, the target client based on a creator, an executor and/or a follower of the task included in the editing data of the task.

In some examples, the task creation module is further specifically configured to:
receive, by the task server, an opening request of a task panel transmitted by the target client, where the opening request includes: the index information of the task; and
transmit, by the task server, the editing data of the task to the target client based on the index information of the task, such that the target client displays the task based on the editing data of the task.

In some examples, the displaying module includes:
a preset key configured to create, in response to the specified operation completed in the preset panel, the task in the target client on the premise of being selected; or
a check box, where prompt information is correspondingly displayed near the check box, and the prompt information is configured to give a prompt of creating, in response to the specified operation completed in the preset panel, the task in the target client in a case that the check box is selected.

In some examples, the displaying module includes a first display unit configured to:
display, in response to the invocation operation for the person selection component panel in the task type block of the first document by inputting a preset character, the person selection component panel and the target option in the person selection component panel; or
display, in response to the invocation operation for the person selection component panel in the task type block of the first document by clicking on a person selection component icon, the person selection component panel and the target option in the person selection component panel.

In some examples, the displaying module further includes a second display unit configured to:
display, in response to the invocation operation for the date selector panel in the task type block of the first document by clicking on a date selector icon, the date selector panel and the target option in the date selector panel.

It is worth noting that all units and modules included in an example of the apparatus are merely divided according to a functional logic, but are not limited to the above division, as long as the corresponding functions may be achieved. In addition, specific names of all functional units are merely for the convenience of mutual distinguishing, and are not used to limit the protection scope of the disclosure.

The apparatus according to the example of the disclosure may execute the method according to the corresponding examples of the disclosure, and has corresponding functional modules and beneficial effects corresponding to execution of the method.

FIG. 12 is a schematic structural diagram of an example of an apparatus for task creation according to the disclosure. As shown in FIG. 12, the apparatus of the example includes: a creation module 1201 and a processing module 1202. The creation module 1201 is configured to create, in response to an operation of adding a task into a first document, a first task type block in the first document. The processing module 1202 is configured to convert, in response to a triggering operation for a preset control in the first task type block of the first document, the first task type block into a second task type block. The first task type block and the second task type block have different content block types. The processing module 1202 is further configured to create, according to the second task type block, a task corresponding to the second task type block in the first document.

In some examples, the processing module 1202 is specifically configured to convert, in response to a triggering operation for a conversion control in the first task type block of the first document, the first task type block into the second task type block; or display, in response to an invocation operation for a preset panel in the first task type block of the first document, the preset panel and a target option in the preset panel, and convert, in response to a specified operation completed in the preset panel, the first task type block into the second task type block in a case that the target option is selected.

In some examples, the processing module 1202 is specifically configured to convert, in response to a specified operation completed in a person selection component panel, the first task type block into the second task type block in the first document in a case that the target option is selected, where the second task type block displays a date selector icon and personnel information selected through the person selection component panel.

In some examples, the processing module 1202 is specifically configured to convert, in response to a specified operation completed in a date selector panel, the first task type block into the second task type block in the first document in a case that the target option is selected, where the second task type block displays a person selection component icon and time information selected through the date selector panel.

In some examples, the second task type block further displays a first icon and a second icon. The first icon is configured to enter a task center after being triggered. The second icon is configured to follow the task after being triggered.

In some examples, the processing module 1202 is further configured to display, when a focus is located on the first task type block, a first content block type identifier in an associated zone of the first task type block; and display, when a focus is located on the second task type block, a second content block type identifier in an associated zone of the second task type block.

In some examples, the task center is integrated in an instant messaging client.

FIG. 13 is a schematic diagram of an electronic device according to an example of the disclosure. As shown in FIG. 11, the electronic device includes a processor 810, a memory 820, an input unit 830, and an output unit 840. A number of processors 810 in the electronic device may be one or more. FIG. 11 takes one processor 810 as an instance. The processor 810, the memory 820, the input unit 830 and the output unit 840 in the electronic device may be connected by means of a bus or in other modes. FIG. 11 takes a bus connection as an instance.

As a computer-readable storage medium, the memory 820 may be configured to store a software program, a computer-executable program, and a module, such as a program instruction/module corresponding to the method for task creation in the example of the disclosure. The processor 810 executes various functional applications and data processing of the electronic device by running the software program, the instruction and the module stored in the memory 820, that is, implements the method according to the example of the disclosure.

The memory 820 may mainly include a program storage zone and a data storage zone. The program storage zone may store an operating system and an application required for at least one function. The data storage zone may store data, etc. created according to usage of a terminal. Moreover, the memory 820 may include a high-speed random access memory, and may further include a non-volatile memory, for instance, at least one magnetic disk memory device, a flash memory device, or other non-volatile solid-state memory devices. In some instances, the memory 820 may further include a memory remotely arranged with respect to the processor 810, and the remote memories may be connected to a computer device by means of a network. Instances of the network include, but are not limited to, the Internet, enterprise intranets, local area networks, mobile communication networks, and combinations thereof.

The input unit 830 may be configured to receive input digital or character information and generate key signal input related to user settings and function control of the electronic device, and may include a keyboard, a mouse, etc. The output unit 840 may include a display device such as a display screen.

An example of the disclosure further provides a storage medium including a computer-executable instruction. The computer-executable instruction is configured to implement the method according to the example of the disclosure when being executed by a processor of a computer.

Obviously, in the storage medium including the computer-executable instruction according to the example of the disclosure, the computer-executable instruction is not limited by the method operations, and related operations in the method according to any example of the disclosure may also be executed.

The disclosure further provides a computer program product. When the computer program product runs on a computer, the computer is caused to execute the method of the application according to the above examples.

In some examples, in a first aspect, the disclosure provides a method for task creation. The method includes the following steps:
in response to an operation of adding a task into a first document, a task type block is created in the first document;
in response to an invocation operation for a preset panel in the task type block of the first document, the preset panel is displayed and a target option is displayed in the preset panel, where the target option is configured to give a prompt that a task corresponding to the task type block is to be triggered to be created in a target client when being selected; and
in response to a specified operation completed in the preset panel, the task corresponding to the task type block is created in the target client in a case that the target option is selected.

In some examples, the steps that in response to the invocation operation for the preset panel in the task type block of the first document, the preset panel is displayed and the target option is displayed in the preset panel include the following steps:
in response to an invocation operation for a person selection component panel in the task type block of the first document, the person selection component panel is displayed and the target option is displayed in the person selection component panel.

In some examples, the steps that in response to the invocation operation for the preset panel in the task type block of the first document, the preset panel is displayed and the target option is displayed in the preset panel include the following steps:
in response to an invocation operation for a date selector panel in the task type block of the first document, the date selector panel is displayed and the target option is displayed in the date selector panel.

In some examples, the step that the task corresponding to the task type block is created in the target client includes the following steps:
editing information of the task corresponding to the task type block is transmitted to a task server, where the editing information includes: index information of the task and editing data of the task, and then the task server transmits the index information of the task to the target client, such that the target client creates the task based on the index information of the task.

In some examples, the editing data of the task includes: a creator, an executor, and/or a follower of the task.

The target client is determined by the task server based on the creator, the executor and/or the follower of the task included in the editing data of the task.

In some examples, the specified operation includes:
an operation of selecting the executor and/or the follower of the task; or an operation of selecting reminder time and/or a deadline of the task.

In some examples, the target option includes:
a preset key configured to create, in response to the specified operation completed in the preset panel, the task in the target client on the premise of being selected; or
a check box, where prompt information is correspondingly displayed near the check box, and the prompt information is configured to give a prompt of creating, in response to the specified operation completed in the preset panel, the task in the target client in a case that the check box is selected.

In some examples, the steps that in response to the invocation operation for the person selection component panel in the task type block of the first document, the person selection component panel is displayed and the target option is displayed in the person selection component panel include the following steps:
in response to the invocation operation for the person selection component panel in the task type block of the first document by inputting a preset character, the person selection component panel is displayed and the target option is displayed in the person selection component panel; or
in response to the invocation operation for the person selection component panel in the task type block of the first document by clicking on a person selection component icon, the person selection component panel is displayed and the target option is displayed in the person selection component panel.

In some examples, the steps that in response to the invocation operation for the date selector panel in the task type block of the first document, the date selector panel is displayed and the target option is displayed in the date selector panel include the following steps:
in response to the invocation operation for the date selector panel in the task type block of the first document by clicking on a date selector icon, the date selector panel is displayed and the target option is displayed in the date selector panel.

In a second aspect, an example of the disclosure provides an apparatus for task creation. The apparatus includes:
a task type block creation module configured to create, in response to an operation of adding a task into a first document, a task type block in the first document;
a displaying module configured to display, in response to an invocation operation for a preset panel in the task type block of the first document, the preset panel and a target option in the preset panel, where the target option is configured to give a prompt that a task corresponding to the task type block is to be triggered to be created in a target client when being selected; and
a task creation module configured to create, in response to a specified operation completed in the preset panel, the task corresponding to the task type block in the target client in a case that the target option is selected.

In a third aspect, an example of the disclosure provides an apparatus for task creation. The apparatus includes:
a creation module and a processing module. The creation module is configured to create, in response to an operation of adding a task into a first document, a first task type block in the first document. The processing module is configured to convert, in response to a triggering operation for a preset control in the first task type block of the first document, the first task type block into a second task type block. The first task type block and the second task type block have different content block types. The processing module is further configured to create, according to the second task type block, a task corresponding to the second task type block in the first document.

In a fourth aspect, an example of the disclosure provides an electronic device. The electronic device includes:
one or more processors; and
a storage unit configured to store one or more programs.

When the one or more programs are executed by the one or more processors, the one or more processors are caused to implement the method according to the first aspect or the second aspect.

In a fifth aspect, an example of the disclosure provides a computer-readable storage medium, which stores a computer program. When the computer program is executed by a processor, the method according to the first aspect or the second aspect is implemented.

In a sixth aspect, an example of the disclosure provides a computer program product. When the computer program product runs on a computer, the computer is caused to execute steps of the method according to the first aspect or the second aspect.

It should be noted that relational terms herein such as “first” and “second” are only used to distinguish one entity or operation from another entity or operation without necessarily requiring or implying any actual such relation or order between such entities or operations. In addition, terms “include”, “comprise”, “contain”, or any other variations thereof are intended to cover non-exclusive inclusions, such that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other identical elements in the process, method, article, or device including the elements.

What are described above are only specific embodiments of the disclosure, such that those skilled in the art can understand or implement the disclosure. Various modifications to the examples are readily obvious to those skilled in the art, and the general principles defined herein can be implemented in other examples without departing from the spirit or scope of the disclosure. Therefore, the disclosure is not limited to the examples shown herein but falls within the widest scope consistent with the principles and novel features disclosed herein.

1. A method for task creation, comprising:
creating, in response to an operation of adding a task into a first document, a task type block in the first document;
displaying, in response to an invocation operation for a preset panel in the task type block of the first document, the preset panel and a target option in the preset panel, wherein the target option is configured to give a prompt that a task corresponding to the task type block is to be triggered to be created in a target client in response to being selected; and
creating, in response to a specified operation completed in the preset panel, the task corresponding to the task type block in the target client in a case that the target option is selected.

2. The method according to claim 1, wherein the displaying, in response to an invocation operation for a preset panel in the task type block of the first document, the preset panel and a target option in the preset panel comprises:
displaying, in response to an invocation operation for a person selection component panel in the task type block of the first document, the person selection component panel and the target option in the person selection component panel.

3. The method according to claim 1, wherein the displaying, in response to an invocation operation for a preset panel in the task type block of the first document, the preset panel and a target option in the preset panel comprises:
displaying, in response to an invocation operation for a date selector panel in the task type block of the first document, the date selector panel and the target option in the date selector panel.

4. The method according to claim 1, wherein the creating the task corresponding to the task type block in the target client comprises:
transmitting, to a task server, editing information of the task corresponding to the task type block, wherein the editing information comprises: index information of the task and editing data of the task, and
transmitting, by the task server, the index information of the task to the target client, such that the target client creates the task based on the index information of the task.

5. The method according to claim 4, wherein the editing data of the task comprises:
a creator, an executor, and/or a follower of the task; and
the target client is determined by the task server based on the creator, the executor and/or the follower of the task comprised in the editing data of the task.

6. The method according to claim 1, wherein the specified operation comprises:
an operation of selecting the executor and/or the follower of the task; or an operation of selecting reminder time and/or a deadline of the task.

7. The method according to claim 2, wherein the target option comprises:
a preset key configured to create, in response to the specified operation completed in the preset panel, the task in the target client on the premise of being selected; or
a check box, wherein prompt information is correspondingly displayed near the check box, and the prompt information is configured to give a prompt of creating, in response to the specified operation completed in the preset panel, the task in the target client in a case that the check box is selected.

8. The method according to claim 2, wherein the displaying, in response to an invocation operation for a person selection component panel in the task type block of the first document, the person selection component panel and the target option in the person selection component panel comprises:
displaying, in response to the invocation operation for the person selection component panel in the task type block of the first document by inputting a preset character, the person selection component panel and the target option in the person selection component panel; or
displaying, in response to the invocation operation for the person selection component panel in the task type block of the first document by clicking on a person selection component icon, the person selection component panel and the target option in the person selection component panel.

9. The method according to claim 3, wherein the displaying, in response to an invocation operation for a date selector panel in the task type block of the first document, the date selector panel and the target option in the date selector panel comprises:
displaying, in response to the invocation operation for the date selector panel in the task type block of the first document by clicking on a date selector icon, the date selector panel and the target option in the date selector panel.

10. A method for task creation, comprising:
creating, in response to an operation of adding a task into a first document, a first task type block in the first document;
converting, in response to a triggering operation for a preset control in the first task type block of the first document, the first task type block into a second task type block, wherein the first task type block and the second task type block have different content block types; and
creating, according to the second task type block, a task corresponding to the second task type block in the first document.

11. The method according to claim 10, wherein the converting, in response to a triggering operation for a preset control in the first task type block of the first document, the first task type block into a second task type block comprises:
converting, in response to a triggering operation for a conversion control in the first task type block of the first document, the first task type block into the second task type block; or
displaying, in response to an invocation operation for a preset panel in the first task type block of the first document, the preset panel and a target option in the preset panel, and converting, in response to a specified operation completed in the preset panel, the first task type block into the second task type block in a case that the target option is selected.

12. The method according to claim 11, wherein the converting, in response to a specified operation completed in the preset panel, the first task type block into the second task type block in a case that the target option is selected comprises:
converting, in response to a specified operation completed in a person selection component panel, the first task type block into the second task type block in the first document in a case that the target option is selected, wherein the second task type block displays a date selector icon and personnel information selected through the person selection component panel.

13. The method according to claim 11, wherein the converting, in response to a specified operation completed in the preset panel, the first task type block into the second task type block in a case that the target option is selected comprises:
converting, in response to a specified operation completed in a date selector panel, the first task type block into the second task type block in the first document in a case that the target option is selected, wherein the second task type block displays a person selection component icon and time information selected through the date selector panel.

14. The method according to claim 12, wherein the second task type block further displays a first icon and a second icon, wherein the first icon is configured to enter a task center after being triggered, and the second icon is configured to follow the task after being triggered.

15. The method according to claim 10, further comprising:
displaying, in a case that a focus is located on the first task type block, a first content block type identifier in an associated zone of the first task type block; and
displaying, in a case that a focus is located on the second task type block, a second content block type identifier in an associated zone of the second task type block.

16. The method according to claim 14, wherein the task center is integrated in an instant messaging client.

17-18. (canceled)

19. An electronic device, comprising:
one or more processors; and
a storage unit configured to store one or more programs, wherein
when the one or more programs are executed by the one or more processors, the one or more processors are caused to:
create, in response to an operation of adding a task into a first document, a task type block in the first document;
display, in response to an invocation operation for a preset panel in the task type block of the first document, the preset panel and a target option in the preset panel, wherein the target option is configured to give a prompt that a task corresponding to the task type block is to be triggered to be created in a target client in response to being selected; and
create, in response to a specified operation completed in the preset panel, the task corresponding to the task type block in the target client in a case that the target option is selected.

20-21. (canceled)

22. The electronic device according to claim 19, wherein the displaying, in response to an invocation operation for a preset panel in the task type block of the first document, the preset panel and a target option in the preset panel comprises:
displaying, in response to an invocation operation for a person selection component panel in the task type block of the first document, the person selection component panel and the target option in the person selection component panel.

23. The electronic device according to claim 19, wherein the displaying, in response to an invocation operation for a preset panel in the task type block of the first document, the preset panel and a target option in the preset panel comprises:
displaying, in response to an invocation operation for a date selector panel in the task type block of the first document, the date selector panel and the target option in the date selector panel.

24. The electronic device according to claim 19, wherein the creating the task corresponding to the task type block in the target client comprises:
transmitting, to a task server, editing information of the task corresponding to the task type block, wherein the editing information comprises: index information of the task and editing data of the task.
